(19) United States
(12) Patent Application Publication
(10) Pub. No.: US 2025/0365688 A1
(43) Pub. Date: Nov. 27, 2025

(54) PREVENTING FRAUD DURING SMSF REGISTRATION

(71) Applicant: T-Mobile USA, Inc., Bellevue, WA (US)

(72) Inventors: Subramania Kaushik, Bellevue, WA (US); Anil Kumar Mariyani, Ashburn, VA (US)

(21) Appl. No.: 18/671,815

(22) Filed: May 22, 2024

(51) Int. Cl. H04W 60/04; H04L 41/5009; H04W 4/14

(52) U.S. Cl. CPC H04W 60/04; H04L 41/5009; H04W 4/14

(57) ABSTRACT

Described herein are a short message service function (SMSF) and unified data management node (UDM) configured to transmit and receive a permanent equipment identifier (PEI) associated with a user equipment (UE) during SMSF registration. After receiving the PEI from the SMSF, the UDM compares the received PEI to a PEI stored during a network registration for the UE. If there is a match, SMSF registration is allowed. If the received PEI does not match the stored PEI, SMSF registration is denied.

### BACKGROUND

As networks evolve, new opportunities for security exploits are created. Operators of these networks proactively identify these opportunities and provide additional security checks to ensure secure connected experiences for their users.

Users spend much of their time connected in messaging one another. The messaging applications use any of a number of different messaging protocols, such as the short message service (SMS) protocol. In Fifth Generation (5G) networks, the setup for SMS messaging involves a network function called the SMS function (SMSF) which, as part of its registration, exchanges messages with a unified data management node (UDM). Security exploits during SMSF registration, such as those bypassing authentication and authorization flows, can result in an SMS getting delivered to a wrong recipient.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIGS. 1A-1B are overviews diagram of fraud during short message service function (SMSF) registration and of transmission and verification of a permanent equipment identifier (PEI) as part of SMSF registration to prevent fraud.

FIG. 2 is a network message diagram showing transmissions and uses of a PEI for a user equipment (UE) to prevent fraud during SMSF registration.

FIG. 3 is a flow diagram of an illustrative process for operations by a unified data management node (UDM) to receive PEIs during network registration and SMSF registration, to determine if the PEIs match, and to allow or deny SMSF registration based on whether the PEIs match.

FIG. 4 is a flow diagram of an illustrative process for operations by an SMSF to send a PEI to a UDM during SMSF registration and to receive a message indicating that the SMSF registration is allowed or denied based on whether the PEI matches a PEI previously received by the UDM.

FIG. 5 is a schematic diagram of a computing device capable of implementing a UDM or SMSF.

### DETAILED DESCRIPTION

This disclosure is directed in part to preventing fraud during short message service function (SMSF) registration by comparing a permanent equipment identifier (PEI) received during SMSF registration to a previously received PEI. During SMSF registrations, the SMSF sends a message that includes a PEI associated with a user equipment (UE) to a unified data management node (UDM). The UDM may have previously received that PEI during a network registration for the UE. After receiving the PEI from the SMSF, the UDM compares the received PEI to the PEI stored during the network registration for the UE. If there is a match, SMSF registration is allowed. If the received PEI does not match the stored PEI, SMSF registration is denied.

In addition to denying the SMSF registration, the UDM or another node (e.g. the SMSF or an access and mobility management function (AMF)) may send a message to an equipment identity register (EIR) blacklisting or greylisting the UE associated with the PEI sent during SMSF registration.

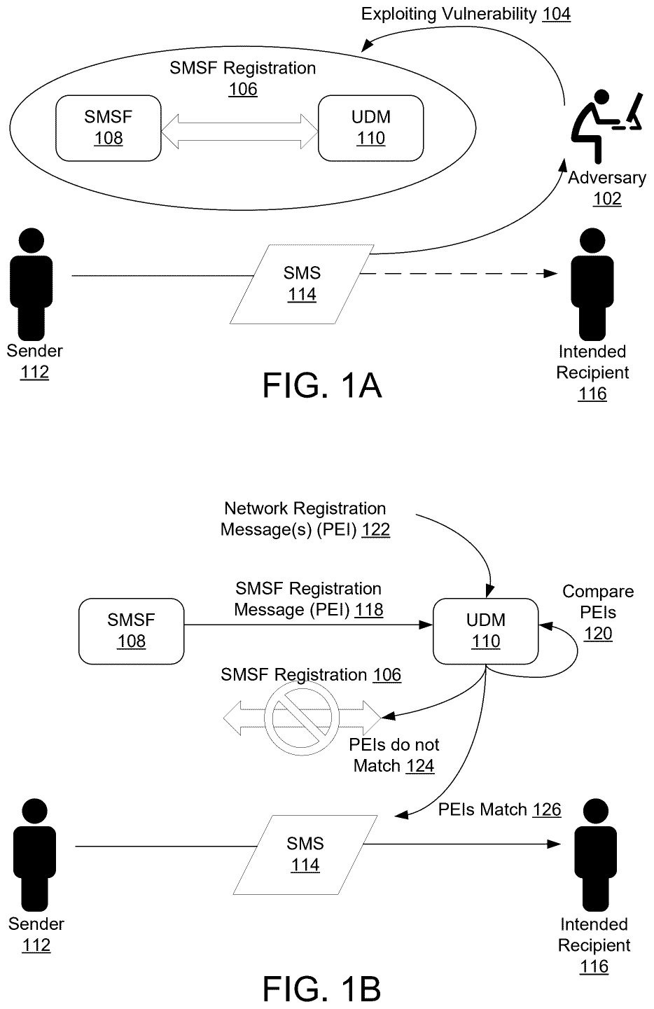

FIGS. 1A-1B are overviews diagram of fraud during short message service function (SMSF) registration and of transmission and verification of a permanent equipment identifier (PEI) as part of SMSF registration to prevent fraud. As shown in FIG. 1A, an adversary 102, such as a hacker or other exploiter of security vulnerabilities, may exploit, at 104, a vulnerability of SMSF registration 106. As noted herein, SMSF registration 106 involves an SMSF 108 sending one or more messages to a UDM 110 and receiving one or more messages in return, followed if successful by a sender 112—who was the subject of the SMSF registration 106, sending an SMS 114. Without exploiting, at 104, the security vulnerability, the SMS 114 would be delivered to the intended recipient 116. The security vulnerability may be used, however, to divert the SMS 114 to the adversary 102. Such security vulnerabilities can allows adversaries 102 to acquire private information from users such as sender 112.

In FIG. 1B, the privacy of sender 112 is protected by preventing successful SMSF registration 106 if an adversary 102 is exploiting, at 104, a security vulnerability. As illustrated, the SMSF 108 sends an SMSF registration message 118 which may be configured to include a PEI as a parameter of the message 118. At 120, the UDM may compare the PEI received in the message 118 to a PEI stored by a unified data repository (UDR) of the UDM 110. The stored PEI may have previously been received by the UDM 110 in a network registration message 122, as it may be a parameter of such a message. Treating this earlier received and stored PEI as a ground truth, the UDM 110 can determine if the PEI in the message 118 matches. A mismatch indicates that the adversary 102 has exploited, at 104, the vulnerability. A match would indicate that no exploit is detected. At 124, when there is a mismatch, the SMSF registration 106 is denied and SMS messaging, such as the sending of SMS 114, does not occur. At 126, when there is a match, SMSF registration 106 proceeds and the sender 112 is able to send the SMS 114 to the intended recipient 116.

In various implementations, a network operator can take further precautions against future security exploits by having the UDM 110, SMSF 108, or an AMF blacklist or greylist a UE associated with the mismatching PEI. So in addition to denying the SMSF registration 106 at 124 when the PEI from message 118 does not match the PEI from message 122, the network operator can place the presumed UE of the adversary 102, the UE associated with the PEI from message 118, on a blacklist or greylist to deny it further access to the telecommunications network of the operator.

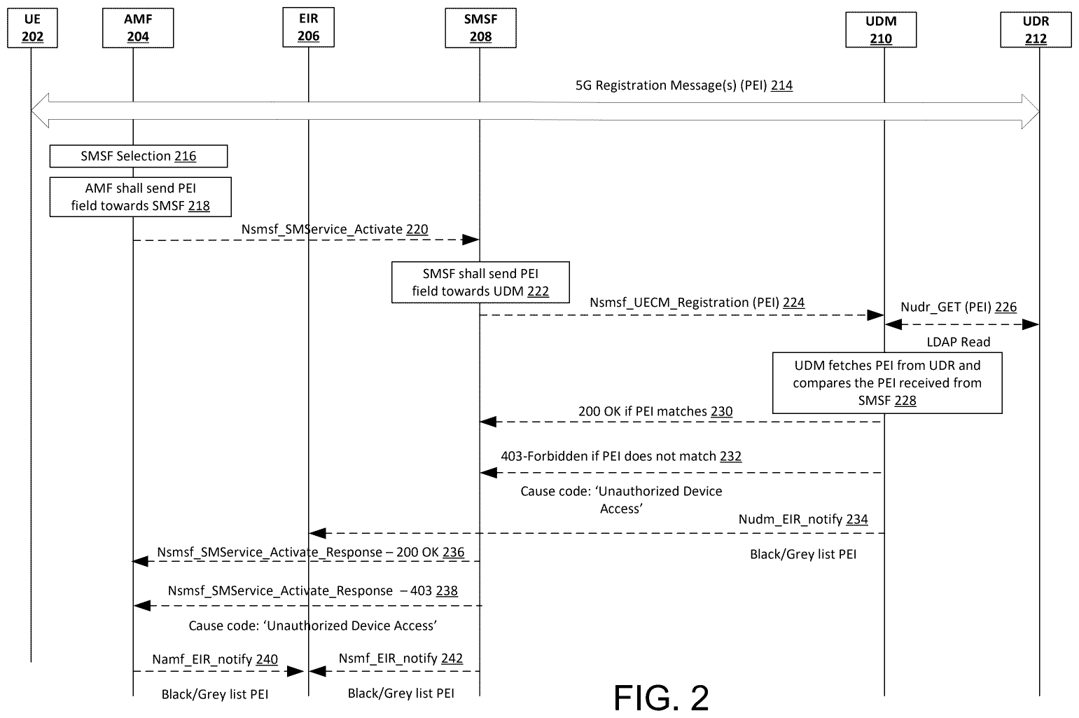

FIG. 2 is a network message diagram showing transmissions and uses of a PEI for a user equipment (UE) to prevent fraud during SMSF registration. A UE 202 and five nodes of a Fifth Generation (5G) core network are shown along with a series of messages passed among the UE 202 and nodes and operations performed by ones of the nodes.

In various implementations, the UE 202 may be any sort of computing device capable of wireless communication such as a mobile phone, tablet computer, watch, goggles, Internet-of-Things (IoT) device, permanent computer, etc. The UE 202 may be the UE of an adversary 102, sender 112, intended recipient 116, or other user of the telecommunications network that includes nodes 204-212.

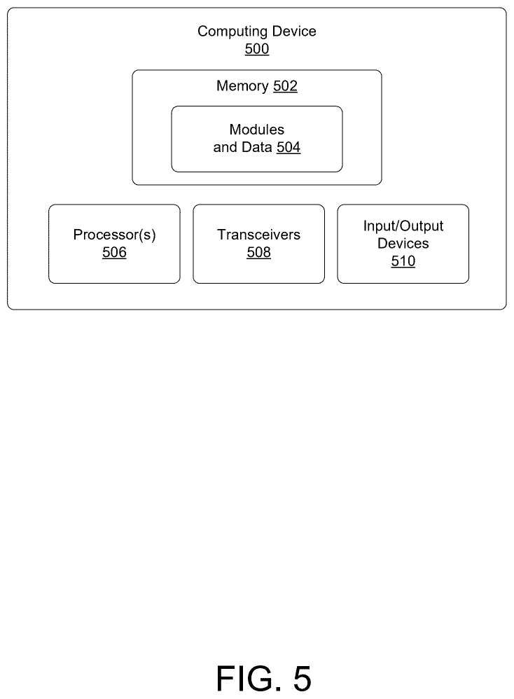

The illustrated nodes of the telecommunications network are the AMF 204, EIR 206, SMSF 208, UDM 210, and UDR 212. These nodes all belong to or communicate with the 5G core network of the telecommunications network, which may also include other nodes and functions. While a separate box is shown for each of nodes 204-212, it is to be understood that any two or more of the nodes 2014-212 may be co-located on a computing device (such as, e.g., the computing device illustrated in FIG. 5) or on separate computing devices linked by wired or wireless mechanism(s). In addition to the 5G core network, the telecommunications network may also include access network(s) (not shown), such as radio access network(s) in different physical location(s) for communicating with UE 202 and other UEs as they move about.

The AMF 204, EIR 206, SMSF 208, UDM 210, and UDR 212 may each perform functions they are configured to perform—e.g., in Third Generation Partnership Program (3GPP) standards—and may also perform operations shown in FIGS. 2-4 and described herein, as well as operations associated with the messages illustrated in FIG. 2.

In various implementations, prior to SMSF registration, the UE 202 and ones of nodes 204-212 may perform a network registration, including one or more 5G registration message(s) 214. At least one of the network messages received by the UDM 210 may include a PEI of the UE 202 as a message parameter and the UDM 210 may store the PEI it the UDR 212. In an example network registration, the UE 202 may send a registration request to the access network that it is connected to. In response, the access network may select an AMF—in this example, AMF 204—and send the registration request to the selected AMF 204. Security is then authenticated between the AMF 204 and UE 202 and among various nodes of the 5G core network. The AMF 204 selects a UDM—here, UDM 210—and sends an Nudm_uecm_registration message, with the PEI of the UE 202 as a parameter. The AMF 204 may also send a subscriber concealed identifier (SUCI), subscription permanent identifier (SUPI), and/or generic public subscription identifier (GPSI) to the UDM 210 along with the PEI. The UDM 210 may store the PEI in the UDR 212.

Following the network registration, the AMF 204 may perform an SMSF selection procedure at 216. Such an SMSF selection procedure 216 may be performed to select among multiple SMSFs of the 5G core network. The AMF 204 may select SMSF 208 (which may be an example of SMSF 108), and the AMF 204 may send, at 218, at least one message that includes the PEI of the UE 202 towards the selected SMSF 208. For instance, the AMF 204 may send a Nsmsf_SMService_Activate message 220 that includes the PEI as a parameter.

In some implementations, the SMSF 208 may receive the PEI from the AMF 204 and, at 222, send the PEI towards the UDM 210 as part of an SMSF registration (such as SMSF registration 106). For example, the SMSF 208 may send a Nsmsf_UECM_Registration message 224 with the PEI as a parameter.

The UDM 210 (which may be an example of UDM 110), upon receiving the SMSF message 224 with the PEI, may retrieve the stored PEI from the UDR 212 through one or more Nudr_GET and/or LDAP Read messages 226. This stored PEI is the PEI received in 5G registration message(s) 214.

The UDM 210, having fetched the stored PEI, compares at 228 the PEI received in message 224 to the stored PEI. As a result of the comparison at 228, the UDM 210 may send different message(s) to different ones of the EIR 206 and/or SMSF 208. For example, if the PEI from message 224 matches the stored PEI, the UDM 210 may send a 200 OK message 230 to the SMSF 208, signifying to the SMSF 208 that the SMSF registration is allowed. In contrast, if the PEI from message 224 does not match the stored PEI, the UDM 210 may send a 403-forbidden message 232 to the SMSF 208, signifying that SMSF registration is denied. Further, in some examples, if the PEI from message 224 does not match the stored PEI, the UDM 210 may also send an Nudm_EIR_notify message 234 to blacklist or greylist the UE 202 associated with the PEI from the message 224.

In various implementations, the SMSF 208 is configured to receive a response to message 224, such as the 200 OK message 230 or the 403-forbidden message 232 signifying, respectively, that the SMSF registration is allowed or denied. These responses are, in turn, each associated with the SMSF 208 sending on a different response to the AMF 204. If receiving a 200 OK message 230, the SMSF 208 may send a Nsmsf_SMService_Activate response-200 OK message 236 to the AMF 204 informing the AMF 204 that SMSF registration is successful. On the other hand, if receiving a 403-forbidden message 232, the SMSF 208 may send a Nsmsf_SMService_Activate response—403-forbidden message 238 to the AMF 204 indicating that the SMSF registration has been denied. The message 238 can further include a cause code, such as “Unauthorized device access”.

In some implementations, receiving a message 238, or receiving such a message with a cause code of “unauthorized device access”, may trigger the AMF 204 to send a Namf_EIR_Notify message 240 to the EIR 206 to blacklist or greylist the UE 202. The EIR 206 may maintain a blacklist or greylist of UEs.

Additionally or alternatively, the SMSF 208 may itself message the EIR 206, sending a Nsmf_EIR_notify message 242 to the EIR 206 to blacklist or greylist the UE 202.

Further, in various implementations the SMSF 208 may implement one or more key performance indicators (KPIs) associated with SMSF registration failures. Such KPIs could include a total number of SMSF registration attempts, a total number of SMSF registration failures, a percentage of attempted SMSF registrations that fail, etc. The SMSF 208 may provide the KPIs to an element monitory system, and from there to a monitoring platform of the network operator.

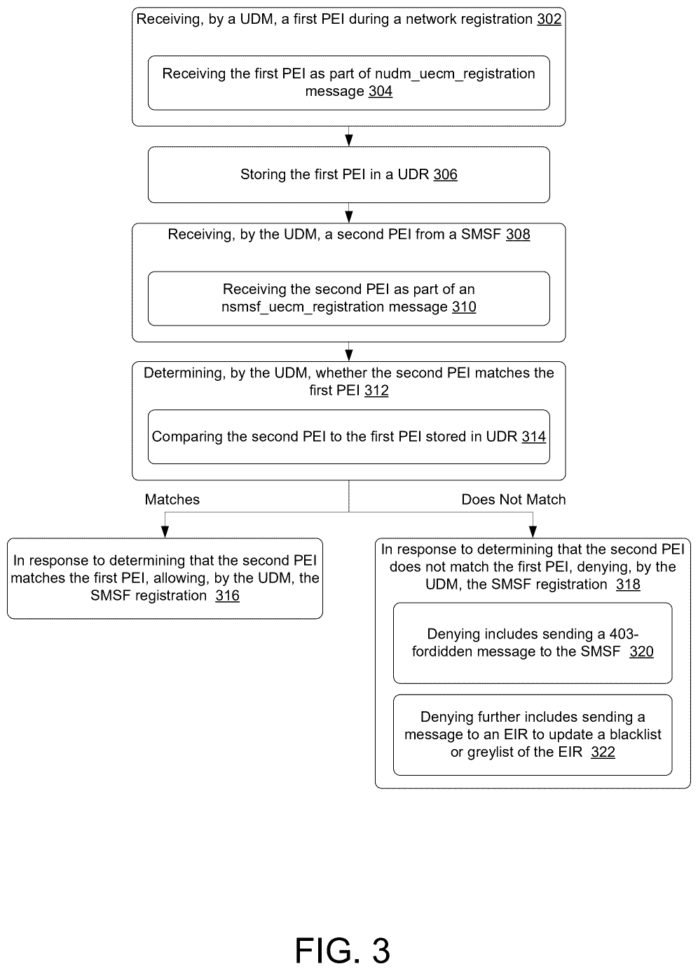

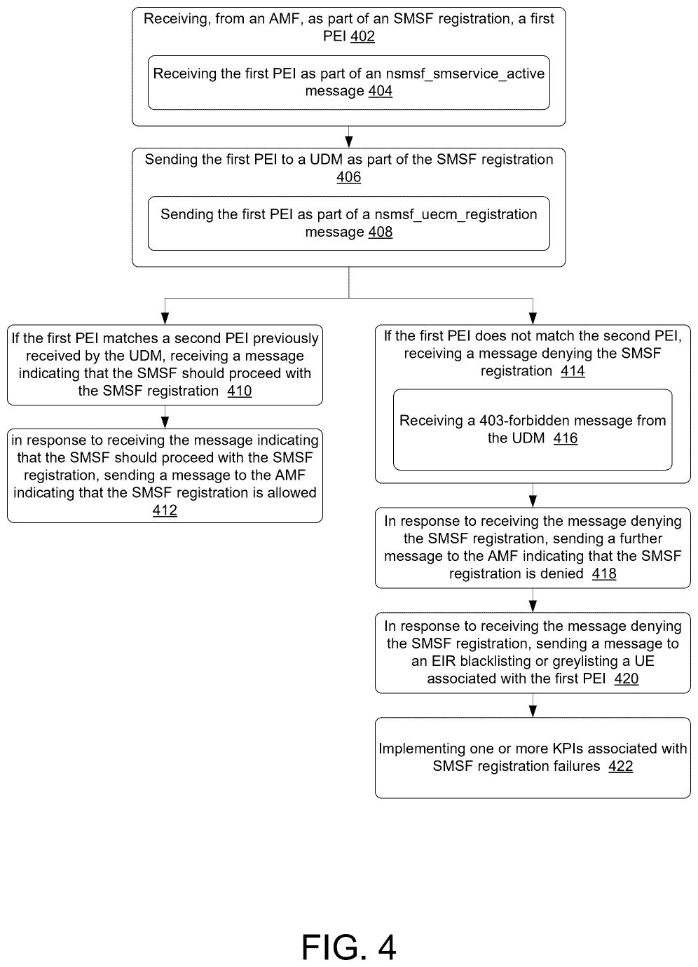

FIGS. 3 and 4 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flow diagram of an illustrative process for operations by a unified data management node (UDM) to receive PEIs during network registration and SMSF registration, to determine if the PEIs match, and to allow or deny SMSF registration based on whether the PEIs match. As illustrated at 302, a UDM receives a first PEI during a network registration. At 304, receiving the first PEI may comprise receiving the first PEI as part of nudm_uecm_registration message.

At 306, the UDM may store the first PEI in a UDR.

At 308, the UDM receives a second PEI from a SMSF. At 310, receiving the second PEI may comprise receiving the second PEI as part of a nsmsf_uecm_registration message.

At 312, the UDM determines whether the second PEI matches the first PEI. At 314, the determining may include comparing the second PEI to the first PEI stored in UDR.

At 316, in response to determining that the second PEI matches the first PEI, the UDM allows the SMSF registration.

At 318, in response to determining that the second PEI does not match the first PEI, the UDM denies the SMSF registration. At 320, the denying may include sending a 403-forbidden message to the SMSF. At 322, the denying may further include sending a message to an EIR to update a blacklist or greylist of the EIR.

FIG. 4 is a flow diagram of an illustrative process for operations by an SMSF to send a PEI to a UDM during SMSF registration and to receive a message indicating that the SMSF registration is allowed or denied based on whether the PEI matches a PEI previously received by the UDM. As illustrated at 402, an SMSF receives from an AMF, as part of an SMSF registration, a first PEI. At 404, the receiving may comprise receiving the first PEI as part of an nsmsf_smservice_active message.

At 406, the SMSF sends the first PEI to UDM as part of the SMSF registration. At 408, the sending may comprise sending the first PEI as part of a nsmsf_uecm_registration message.

At 410, if the first PEI matches the second PEI previously received by the UDM, the SMSF receives a message indicating that the SMSF should proceed with the SMSF registration.

At 412, in response to receiving the message indicating that the SMSF should proceed with the SMSF registration, the SMSF may send a message to the AMF indicating that the SMSF registration is allowed.

At 414, if the first PEI does not matches the second PEI previously received by the UDM, the SMSF receives a message denying the SMSF registration. At 416, receiving the message denying the SMSF registration may comprise receiving a 403-forbidden message from the UDM.

At 418, in response to receiving the message denying the SMSF registration, the SMSF may send a further message to the AMF indicating that the SMSF registration is denied. Sending the further message may enable the AMF to send a message to an EIR blacklisting or greylisting a UE associated with the first PEI.

At 420, in response to receiving the message denying the SMSF registration, the SMSF may send a message to an EIR blacklisting or greylisting a UE associated with the first PEI.

At 422, the SMSF may implement one or more KPIs associated with SMSF registration failures. While operation 422 is shown following operations 402-420, it is to be understood that implementing KPIs may occur before, during, or after any of operations 402-420.

FIG. 5 is a schematic diagram of a computing device capable of implementing a UDM or SMSF. As shown, the computing device 500 includes a memory 502 storing modules and data 504, processor(s) 506, transceivers 508, and input/output devices 510.

In various examples, the memory 502 can include system memory, which may be volatile (such as RAM), non-volatile (such as ROM, flash memory, etc.) or some combination of the two. The memory 502 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 502 can include one or more software or firmware elements, such as computer-readable instructions that are executable by the one or more processors 506. For example, the memory 502 can store computer-executable instructions associated with modules and data 504. The modules and data 504 can include a platform, operating system, and applications, and data utilized by the platform, operating system, and applications. Further, the modules and data 504 can implement any of the functionality for the SMSF 108, UDM 110, UE 202, AMF 204, EIR 206, SMSF 208, UDM 210, or UDR 212, or any other node/device described and illustrated herein.

In various examples, the processor(s) 506 can be a central processing unit (CPU), a graphics processing unit (GPU), or both CPU and GPU, or any other type of processing unit. Each of the one or more processor(s) 506 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 502, which can be associated with types of volatile (RAM) and/or nonvolatile (ROM) memory.

The transceivers 508 can include modems, interfaces, antennas, Ethernet ports, cable interface components, and/or other components that perform or assist in exchanging wireless communications, wired communications, or both.

While the computing device need not include input/output devices 510, in some implementations it may include one, some, or all of these. For example, the input/output devices 510 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 510 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 510 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A system comprising:
one or more processors;
a unified data management node (UDM) configured to be executed by the one or more processors to receive a first permanent equipment identifier (PEI) during a network registration; and
a short message service function (SMSF) configured to be executed by the one or more processors to perform operations comprising:
receiving, from an access and mobility management function (AMF), as part of an SMSF registration, a second PEI; and
sending the second PEI to the UDM as part of the SMSF registration,
wherein the UDM is further configured to receive the second PEI from the SMSF and determine whether the second PEI matches the first PEI, and
wherein the UDM and SMSF:
in response to the UDM determining that the second PEI matches the first PEI, allow the SMSF registration, and
in response to the UDM determining that the second PEI does not match the first PEI, deny the SMSF registration.

2. The system of claim 1, further comprising an equipment identity register (EIR) configured to receive an identification of the second PEI from the UDM, the SMSF, or the AMF and to include a user equipment (UE) associated with the second PEI on a blacklist or greylist maintained by the EIR.

3. The system of claim 2, wherein the SMSF sends a further message to the AMF indicating that SMSF registration is denied and, by sending the further message, enables the AMF to send a message to the EIR to blacklist or greylist the UE associated with the second PEI.

4. The system of claim 1, further comprising a unified data repository (UDR) to store the first PEI, wherein the determining comprises comparing the second PEI to the first PEI stored in UDR.

5. The system of claim 1, wherein the SMSF, in response to the UDM determining that the second PEI matches the first PEI, receives a message from the UDM allowing the SMSF registration and sends a further message to the AMF indicating that the SMSF registration is allowed.

6. A method comprising:
receiving, by a unified data management node (UDM), a first permanent equipment identifier (PEI) during a network registration;
receiving, by the UDM, a second PEI from a short message service function (SMSF);
determining, by the UDM, whether the second PEI matches the first PEI;
in response to determining that the second PEI matches the first PEI, allowing, by the UDM, the SMSF registration; and
in response to determining that the second PEI does not match the first PEI, denying, by the UDM, the SMSF registration.

7. The method of claim 6, wherein the denying includes sending a 403-forbidden message to the SMSF.

8. The method of claim 6, wherein the denying further includes sending a message to an equipment identity register (EIR) to update a blacklist or greylist of the EIR.

9. The method of claim 6, wherein receiving the second PEI comprises receiving the second PEI as part of an nsmsf_uecm_registration message.

10. The method of claim 6, wherein receiving the first PEI comprises receiving the first PEI as part of nudm_uecm_registration message.

11. The method of claim 6, further comprising storing the first PEI in a unified data repository (UDR), wherein the determining comprises comparing the second PEI to the first PEI stored in UDR.

12. A non-transitory computer storage medium having programming instructions stored thereon that, when executed by one or more processors of a short message service function (SMSF), cause the SMSF to perform operations comprising:
receiving, from an access and mobility management function (AMF), as part of an SMSF registration, a first permanent equipment identifier (PEI);
sending the first PEI to a unified data management node (UDM) as part of the SMSF registration; and
based on whether the first PEI matches a second PEI previously received by the UDM, either:
if the first PEI matches the second PEI, receiving a message indicating that the SMSF should proceed with the SMSF registration, or
if the first PEI does not match the second PEI, receiving a message denying the SMSF registration.

13. The non-transitory computer storage medium of claim 12, wherein the receiving, from the AMF, the first PEI comprises receiving the first PEI as part of an nsmsf_smservice_active message.

14. The non-transitory computer storage medium of claim 12, wherein the sending comprises sending the first PEI as part of a nsmsf_uecm_registration message.

15. The non-transitory computer storage medium of claim 12, wherein the receiving the message denying the SMSF registration comprises receiving a 403-forbidden message from the UDM.

16. The non-transitory computer storage medium of claim 12, wherein the operations further comprise, in response to receiving the message indicating that the SMSF should proceed with the SMSF registration, sending a message to the AMF indicating that the SMSF registration is allowed.

17. The non-transitory computer storage medium of claim 12, wherein the operations further comprise, in response to receiving the message denying the SMSF registration, sending a further message to the AMF indicating that the SMSF registration is denied.

18. The non-transitory computer storage medium of claim 17, wherein the sending the further message enables the AMF to send a message to an equipment identity register (EIR) blacklisting or greylisting a user equipment (UE) associated with the first PEI.

19. The non-transitory computer storage medium of claim 12, wherein the operations further comprise, in response to receiving the message denying the SMSF registration, sending a message to an equipment identity register (EIR) blacklisting or greylisting a user equipment (UE) associated with the first PEI.

20. The non-transitory computer storage medium of claim 12, wherein the operations further comprise implementing one or more key performance indicators (KPIs) associated with SMSF registration failures.
